(19) United States
(12) Patent Application Publication
(10) Pub. No.: US 2006/0160628 A1
(43) Pub. Date: Jul. 20, 2006

(54) IC token, injection molding die for the IC token manufacturing method for the IC token and an IC token selection device

(76) Inventor: Hiroshi Abe, Iwatsuki-shi (JP)

Correspondence Address: SNELL & WILMER LLP, 600 ANTON BOULEVARD, SUITE 1400, COSTA MESA, CA, 92626, US

(21) Appl. No.: 11/318,670

(22) Filed: Dec. 27, 2005

(30) Foreign Application Priority Data
Dec. 28, 2004 (JP) 2004-381357

(51) Int. Cl. A63F 13/00

(52) U.S. Cl. 463/47

(57) ABSTRACT

An IC token for use in a machine such as a gaming device has an IC tag centrally located within a ring of electromagnet wave-absorbing material. The ring is designed to permit a peripheral attachment to the edges of the IC tag with appropriate molding dies to encapsulate the IC token in a resin. The IC token is adapted to be read by a selection device having an antenna along an inclined guide rail while eliminating the possibility of crosstalk between tokens.

### CROSS-REFERENCE TO RELATED APPLICATION

This application is based on an application, number 2004-381357, filed in Japan on Dec. 28, 2004.

### BACKGROUND OF THE INVENTION

1. Field of the Invention

The present invention is directed generally to the field of integrated circuit (IC) tags. More specifically the invention relates to the manufacture and use of IC tags with gaming tokens and gaming machines.

2. Description of Related Art

Gaming devices often require the user to place a token in the gaming device before the user can play a game. The user will place a coin shaped token into a machine and the machine will process the token recognizing the token as a form of payment. In processing the token, some devices take advantage of the size, shape, weight and rolling characteristics of the coin. Some gaming devices such as slot machines may use the token as an integral part of the game. Modem and more sophisticated gaming devices may even require the use of a token that can communicate with the gaming device. One way this can be accomplished is with the use of an IC tag embedded in or mounted on the token.

Conventional IC tags consist of an integrated circuit (IC) attached to an antenna typically a small coil of wire, plus some protective packaging. IC tags can come in a variety of forms and sizes. Data is stored in the IC and transmitted through the antenna to a tag reader. IC tags can be either “passive” or “active”, that is they may be powered by electromagnetic energy from the reader or they may be battery powered. IC tags also can also be read-only, read/write, or a combination in which some data is permanently stored while other memory is left accessible for later encoding and updates.

IC tags packaged in the form of a coin are commonly referred to as IC tokens. The packaging provides the look and feel of a coin, while the IC tag provides a digital storage medium. A gaming device may use information stored in the IC tag to verify the validity of the token or to determine its monetary value. IC tokens are commonly used in Japanese pinball machines, slot machines and other gaming devices. Many non-gaming devices also use IC tokens as a form of payment.

Some special problems occur when an IC token is used in a gaming device. Many gaming devices process the IC token in the same manner as they would process a regular token or a coin. Typically, a token or coin is placed in a slot of a machine where it can be gravity fed past or through some mechanical and electrical measuring devices that determine validity and/or monetary value based on the weight, size, shape or rolling characteristics of the coin. Thus, these attributes are important in the design and manufacture of the IC token. This is especially true, when the token is an integral part of the gaming experience as in a slot machine or when the device uses the weight, size or shape of the token to determine monetary value.

Conventional IC tokens sometimes feature an IC tag in which the integrated circuit is packaged in a light weight plastic resin such as polyphenyline sulfide. This produces an IC token that, compared with a regular token, is light weight and less durable. Such tokens are generally unsuitable for use in gaming devices because of the rigorous environments to which they are exposed. The packaging tends to break down over time as the IC tokens are fed into gaming machines, processed, and dropped into hoppers. However, the use of heavier more durable resins in such an IC token increases the cost of the IC token.

Since these lightweight IC tokens cause problems for gaming devices, techniques have been developed to increase the weight of an IC token. Some IC token designs embed a metal plate with the IC tag in the packaging resin. Other designs increase weight by incorporating a high density material in the resin. Other IC tokens are formed by attaching a metal crest to the IC tag. Some IC tokens are packaged so that an oversized IC tag antenna forms the periphery of the IC token.

Each of these methods for increasing the weight of the IC token can have some inherent problems. For instance, when a metal plate is embedded in the packaging, the metal plate absorbs some of the radio frequency energy generated by the tag reader resulting in less electromagnetic energy reaching the IC tag. If enough energy is absorbed by the metal plate, the IC tag will not receive enough energy to power itself or generate a signal robust enough for the IC reader to interpret. This problem may be overcome by having the token user orient the coin such that the metal plate is not between the IC tag antenna and the IC tag reader. This, however, places a substantive and unrealistic burden on the token user to orient each token before placing it in a gaming device.

A composite IC token, formed by incorporating a high density powder or dense fibers in the resin also poses problems. For example, if an inexpensive dense conductive material such as iron is mixed in with the resin the design engineer encounters an engineering tradeoff. A high ratio of iron powder to resin results in the iron absorbing much of the tag reader's electromagnetic energy while a low ratio results in a light weight token. Use of even more dense materials such as tungsten has been tried but the relatively high cost of such materials makes it an impractical solution.

Sometimes a metal crest is attached to an IC tag to increase its weight and durability. The crest remains affixed to the coin by contact pressure and friction. This solution is also impractical because many gaming parlors inscribe a trade name or an ornamental design on their gaming tokens. Etching, stamping or printing the name on the metal crest is expensive. Moreover, since the crest remains affixed to the token by contact pressure, the token and the crest often become separated during game play.

Finally, there are some manufacturing difficulties with the conventional solution of arranging the IC antenna around the IC tag to form the periphery of an IC token. First, the circumference of the token is larger than necessary for an antenna, and the excessive conductive material required to form the periphery increases the cost of manufacturing the token. Second, since the antenna forms the periphery of the IC token, the antenna gage must be large, presenting packaging difficulties in joining the antenna and IC tag especially when they are joined on a semiconductor substrate.

Accordingly, there is still a need to improve the manner in which IC tokens are rendered compatible for machine use.

### SUMMARY OF THE INVENTION

An object of the present invention is to provide a low cost high density IC token.

A second object of the present invention is to provide a durable IC token featuring an ornamental design.

A third object of the invention is to provide a secure IC token that cannot be accessed unintentionally or illegally.

A fourth object of the invention is to provide an injection molding die that produces the IC token described in the first three objects.

A fifth object of the invention is to provide a method for manufacturing the IC token described in the first three objects.

A sixth object of the invention is to provide a device that discriminates and separates valid IC tokens from other tokens.

According to the present invention, the foregoing and other objects are obtained by; the IC token, the injection molding die, the method of manufacturing the IC token, and the selection device described in this disclosure.

The IC token of the present invention in its various embodiments is characterized by many attributes that make it superior to conventional IC tokens. First, the IC token is durable and dense having a size, shape, and weight similar to a round or polygon shaped coin enabling gaming devices to process the coin in the same way they process conventional tokens. Thus gaming devices may use traditional technologies to process the token. The devices can use differences in size, shape and weight to determine the tokens value as a monetary substitute. The devices may also exploit the rolling characteristics using gravity fed systems that process the coin. In addition, because the IC token has physical attributes similar to conventional tokens and coins, the IC token can be more easily incorporated in games that use the token or coin itself as part of the gaming experience.

Second, the IC token contains an embedded IC tag allowing gaming devices with an IC tag reader to communicate with the IC token. This enables gaming parlors and gaming machines to electronically store information in the IC token. For instance a gaming parlor may store the monetary value of the token on the IC tag. Validity information may also be electronically stored on the IC token enabling gaming devices to determine whether a particular IC token is a valid token for that particular device. A sophisticated gaming device may also read and write to the IC token providing an embedded electronic ledger capability.

Third, the unique packaging of the IC tag allows a gaming device to process multiple tokens in a short period of time without inadvertently reading or writing simultaneously to multiple tokens. An insulating ring mounted around the periphery of the IC tag allows a gaming machine's tag reader to efficiently communicate with each token while reducing the possibility of IC token to IC token cross talk, radio frequency interference, or illegal access. The absence of a metal plate common in some IC tokens means the user may introduce the coin to a gaming machine without concern for the token orientation. And since the IC tag and the insulating ring are bonded through the resin cover, the possibility of the IC tag separating from the insulating ring during normal game play is minimized.

Using an injection molding die of the present invention a manufacturer can mass produce the IC token efficiently and inexpensively. A manufacturer can bond an insulating ring quickly and easily to an IC tag module with an appropriate die. The molding die is designed to accept, align, and retain an insulating ring and IC tag module pair for injection molding. When the pair is placed in the die, hot resin, above the critical temperature of electronics in the IC tag can be injected into the molding die, bonding the IC tag to the insulating ring, without damage to the IC tag electronics.

The injection molding process of the present invention allows a manufacturer to produce the IC token efficiently and inexpensively. Using this process an IC tag is placed into an insulating ring with retention members. The IC tag and insulating ring pair are held together through contact pressure. The pair are then placed on the injection molding die with the insulating ring and the outer circumference of the IC tag suspended in a resin chamber. Hot resin can then be introduced to the chamber without damaging the embedded electronics. When the resin cools, the ring is bonded to the IC tag and the manufacturer has an IC token suitable for use in gaming devices.

The IC selection device of the present invention can be embedded inside a game machine. The IC selection device accepts an IC token and discriminates between valid and invalid IC tokens. The gaming machine senses the IC token, securely communicates with the IC token, determines whether it is a valid or invalid token, and separates valid from invalid tokens. The selection device may also write to the IC token using the IC token as a ledger. The selection device may also communicate information embedded in the IC token to the gaming machine.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a perspective view of a preferred embodiment of the IC token.

FIG. 2 is a plan view of another embodiment of the IC token.

FIG. 3 is a sectional view of the IC token taken from the A-A line shown in FIG. 2.

FIG. 4 is a perspective view of a possible embodiment of the IC tag module portion of the IC token.

FIG. 5 is an alternative embodiment of the insulating ring of the IC token.

FIG. 6 is a diagram of a preferred embodiment of a molding die for producing the IC token.

FIG. 7 is a diagram showing selected steps during the injection molding process.

FIG. 8 is a diagram of the IC token selection device.

### DETAILED DESCRIPTION OF THE PREFERRED EMBODIMENTS

Reference will now be made in detail to the preferred embodiments of the invention which set forth the best modes contemplated to carry out the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

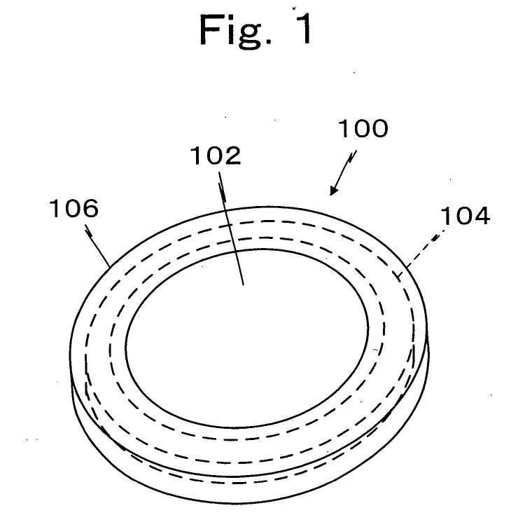

FIG. 1 shows the IC token 100 in a simplistic embodiment with a coin shaped IC tag module 102 surrounded by the insulating ring 104 with a resin cover 106 encapsulating the insulating ring 104 and bonding the insulating ring 104 to the perimeter of the IC tag module 102. The insulating ring 104 circumscribes the disc shaped IC tag module 102 and serves to prevent unintentional and illegal access of the IC tag by attenuating electromagnetic signals radially disposed to the IC tag module 102, protect the IC tag module 102 from mechanical forces, and increase the weight and durability of the IC token 100. Accordingly, the insulating ring 104 is composed of a dense electromagnetic wave absorbing material.

There are many suitable choices of materials for the insulating ring 104. An inexpensive ferromagnetic metal such as iron may be the best choice because of its weight, durability, and wave absorbing characteristics. Brass, nickel, copper and stainless steel may also be good choices since a metallic insulating ring 104 can be formed easily and inexpensively using a punch press. To prevent rust the insulating ring 104 may also be covered with a rust proof protective covering. The insulating ring 104 may also be composed of a nonmetallic wave absorbing material such as a carbon composite.

There are also many suitable materials for the resin cover 106. The resin material should be chosen in part based on its durability and its thermal and electrical properties. A preferred resin choice is polyphenyline sulfide (PPS).

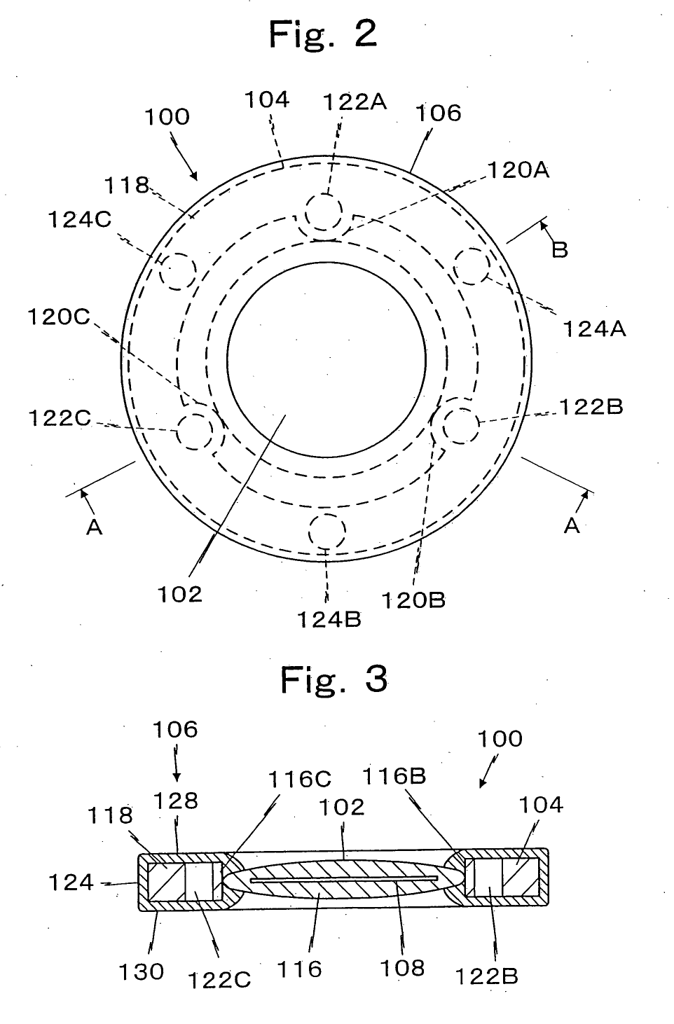

FIG. 2 shows an alternate embodiment of the IC token 100. The basic features from FIG. 1 remain with some variation in form. The insulating ring 104 still features an outer circumference in the form of circular ring 118, however, the inner circumference now features a plurality of retention members 120. The retention members 120 serve to support and hold the IC tag module 102 when it is placed in the insulating ring 104 before the injection molding process. The contact area between the retention members 120 and the IC tag module 102 is small to reduce heat transfer from the insulating ring 104 to the IC tag module 102 during the injection molding process. Through holes 124 facilitate the flow of resin around the insulating ring 104 during the injection molding process. Positioning holes 122 accommodate positioning pins 142 for alignment of the insulating ring 104 in a molding die (not shown).

In this embodiment, positioning holes 122 are strategically placed in the retention members 120 further reducing heat transfer from the insulating ring 104 to the IC tag module 102 during the injection molding process. However in alternate embodiments, the positioning holes 122 may be placed anywhere on the insulating ring 104 or on the outer perimeter of the IC tag module 102.

In this embodiment the positioning holes 122 are circular. However in alternate embodiments the positioning holes may be square, rectangles, polygons or any other suitable shape.

In this embodiment the circular ring 118 is a circular ring. However, in alternate embodiments the ring may be a quadrangle, a polygon or any other suitable shape.

In this embodiment there are three through holes 124. However, alternate embodiments may feature any number of through holes 124 or none at all. Through holes 124, if used, should be strategically placed to enhance the flow of resin around the insulating ring during the injection molding process.

This embodiment shows three circular retention members 120. Three provides mechanical stability and minimizes heat transfer. However, alternate embodiments may feature any number of retention members or, as in FIG. 1, none at all. The retention members may be circular, triangular, square, rectangular or any other suitable shape.

In this embodiment, the resin cover 106 does not completely encapsulate the insulating ring 104, since the retention members 120 are in contact with the IC tag module 102. The positioning holes 122 may or may not be covered by the resin cover 106 depending on whether the positioning pins 142 are retracted the injection molding process. The use of optional retention pins (not shown) during the injection molding process will also leave portions of the insulating ring 104 exposed.

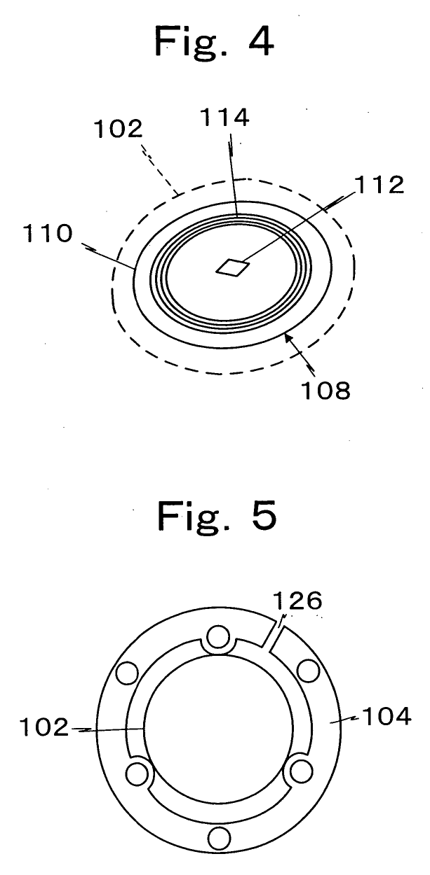

FIG. 3 is the A-A cross section of the embodiment shown in FIG. 2. The IC tag module 102 is lenticular in shape and consists of an IC tag 108 encapsulated within a protective covering 116. Positioning holes 122B and 122C accept positioning pins 142 that align the insulating ring 104 in the molding die (not shown). This view shows the circular ring 118 portion of the insulating ring 104 next to positioning holes 122B and 122C.

In this embodiment, the upper side surface 128 and the lower side surface 130 of the resin cover 106 are flat. The injection molding die may feature a template with lettering or an ornamental design that leaves an impression on the upper side surface 128 and/or the lower side surface 130 of the resin cover 106. Stickers or a stamp pad can also be used to mark the resin cover 106 or the protective covering 116.

In this embodiment, the lenticular shaped IC tag module 102 is recessed between two imaginary planes extending from the upper side surface 128 and the lower side surface 130 protecting the IC tag module 102 from mechanical forces. The resin cover 106 outer circumference is flat from upper side surface 128 to lower side surface 130 forming a thin cylinder that allows the IC token 100 to roll smoothly down an inclined rail (not shown).

The protective covering 116 may be composed of any suitable encapsulating resin. In a preferred embodiment, the protective covering 116 and the resin cover 106 are composed of the same or similar material so that during injection molding process the protective covering 116 and the resin cover 106 are fused together. However, in alternate embodiments the resin cover 106 may be composed of a different material than the protective covering 116.

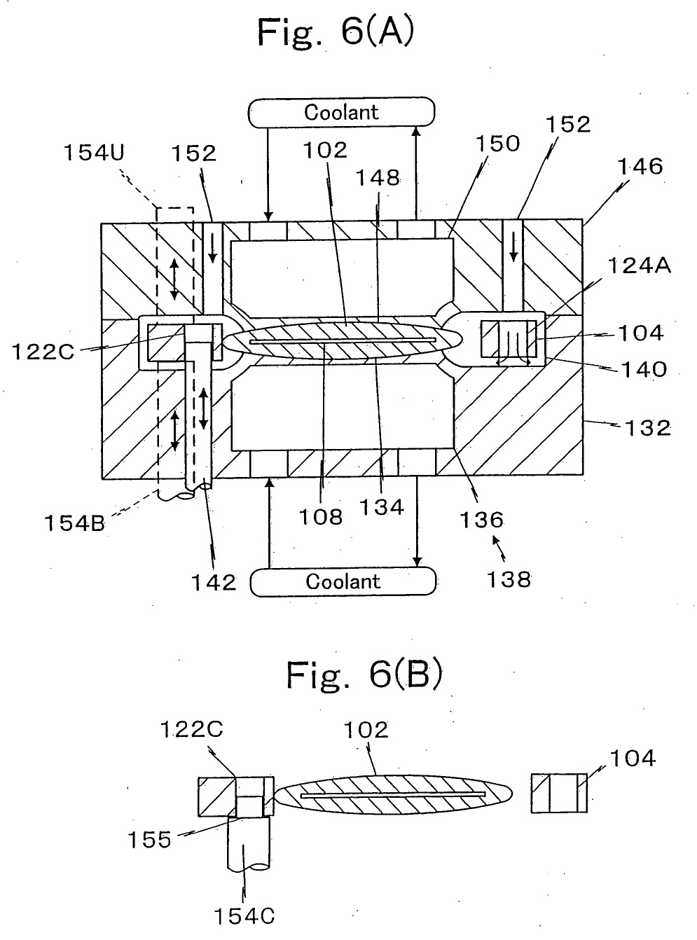

FIG. 4 shows a perspective view of an IC tag module 102. The IC tag module 102 consists of an IC tag 108 encapsulated in the protective covering 116. The IC tag 108 consists of a circular antenna 114 and an integrated circuit (IC) 112 disposed on a semiconductor substrate 110. The IC tag 108 portion of the IC token enables a tag reader (not shown) to communicate with the IC 112. The tag reader may retrieve or store information on the IC 112.

Although, in this embodiment the circular antenna 114 is circular it may also be disposed in any topology suitable for collecting/radiating electromagnetic energy from/to the tag reader (not shown).

In this embodiment the antenna and the IC are joined via a semiconductor substrate. In an alternate embodiment the antenna is coupled to the IC without the use of a substrate 110.

The protective covering 116 may be composed of any suitable material. Many IC tags 108 use a resin such as polyphenylene sulfide because of its durability and excellent thermal and electrical properties.

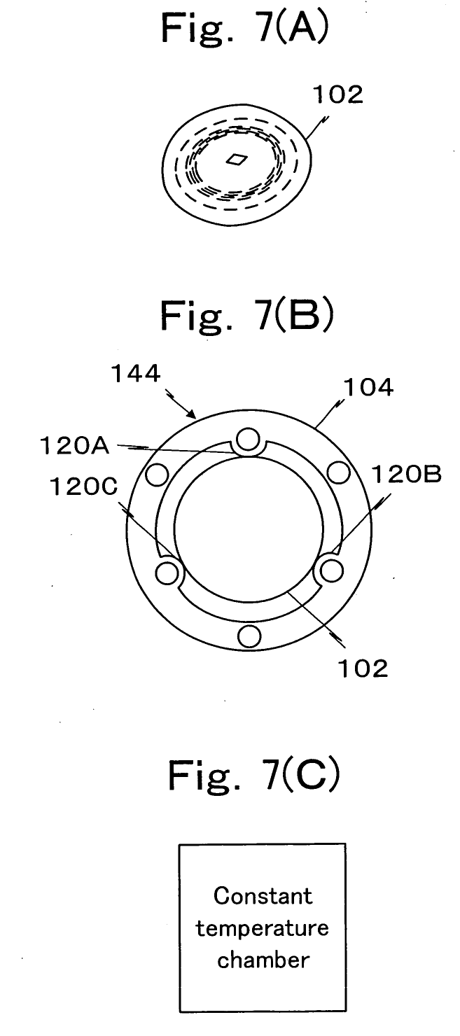

FIG. 5 shows yet another embodiment of the IC token where the insulating ring 104 features a cutout 126 that increases the radio frequency range between the IC tag module 102 and the tag reader (not shown).

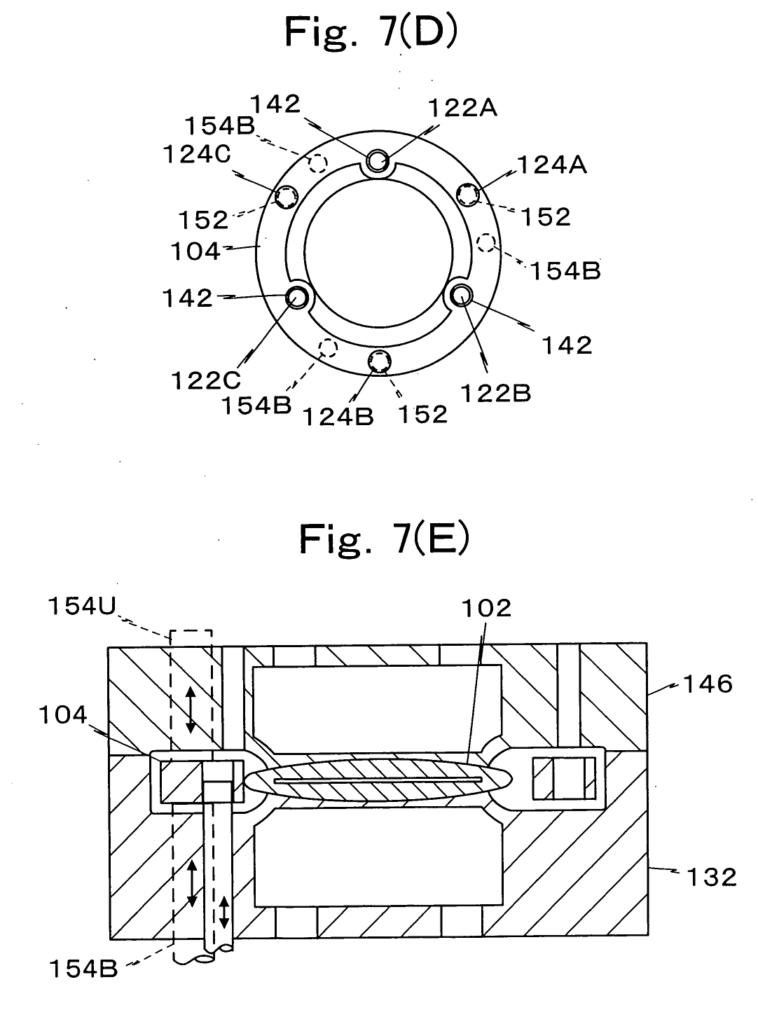

FIG. 6 is an embodiment of the injection molding device used to make the IC token 100. The injection molding device is designed to accept an IC tag module 102 that has been fitted into the insulating ring 104. The lower die 132 contains a lower retention portion 134 that cradles the center of the IC tag module 102. The lower die 132 also feature a concave cavity structure that forms a portion of a resin chamber 140 where resin flows during the injection molding process. Positioning pins 142 mate with the positioning holes 122 when the IC tag module 102 and insulating ring 104 pair are placed on the lower dye. In this position, the IC tag module 102 rests on the lower retention portion 134 with the insulating ring 104 suspended above the concave cavity structure. During the injection molding process, the positioning pins 142 retract to a position where the edge of the positioning pin forms a portion of the resin chamber 140.

The lower die 132 also contains a lower cooling compartment 136 proximate to the lower retention portion 134. A cooling fluid or gas is forced in or out of the compartment to control the temperature of the IC tag module 102 and the resin during the injection molding process. The lower die 132 temperature is maintained hot enough for the liquid resin to flow freely and cool enough so that the IC tag module 102 is not damaged.

During the injection molding process an upper die 146 rests on the lower die 132 with the upper retention portion 148 cradling the center of the IC tag module 102, forming the resin chamber 140 around the insulating ring 104 and the periphery of the IC tag module 102.

When the positioning pins 142 mate with positioning holes 122, the injection inlets 152 are adjacent to through holes 124 allowing the resin to easily flow from the upper portion of the resin chamber 140 to the lower portion of the resin chamber 140.

The upper die 146 and lower die 132 feature upper and lower retention pins 154U and 154B, respectively. The retention pins 154 extend from both the upper die 146 and the lower die 132 die into positioning holes 122 to provide extra stability during the injection molding by securing the insulating ring and dampening vibrations.

The retention pins 154 may feature a planar portion 155 where the positioning pins mate with the insulating ring 104 to further support the insulating ring 104. Since the retention pins 154 do not retract during the injection molding process, the resin cover 106 will feature holes where the retention pins 154 supported the insulating ring 104.

The upper die 146 contains an upper cooling compartment 150 proximate to the IC tag retention portion. Operating similarly to the lower cooling compartment 136, the upper cooling compartment 150 is cooled by forced air or fluid.

Although, this embodiment features both positioning pins 142 and retention pins 154, alternate embodiments may feature only retention pins 154, only positioning pins 142, or neither. This embodiment shows retention pins 154 mating with positioning holes 122. Alternate embodiments may feature retention pins 154 that make contact directly with the insulating ring 104 without the need for a coupling feature like positioning holes 122.

Although this embodiment features both a lower cooling compartment 136 and an upper cooling compartment 155, an alternate embodiment includes either a lower cooling compartment 136 or an upper cooling compartment 155.

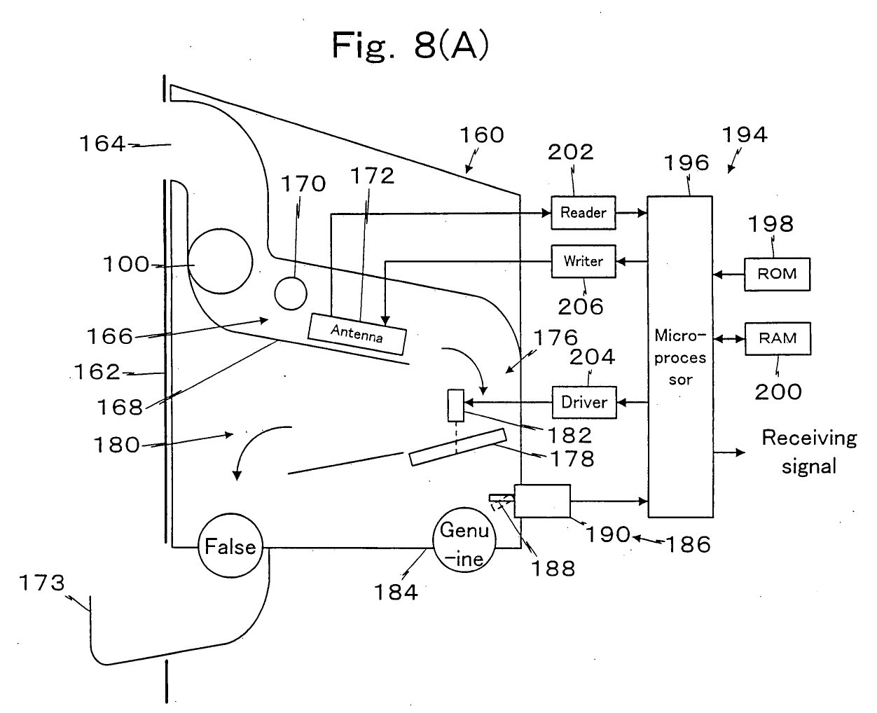

FIG. 7 illustrates selected sequential steps in producing an IC Token 100. FIG. 7a shows a commercially available IC tag module 102. FIG. 7B shows a base module 144 formed by inserting the IC tag module 102 into the insulating ring 104, with retention members 120 of the insulating ring 104 holding the IC tag module 102 through contact pressure. FIG. 7c shows the base module 144 being preheated to a temperature that will allow the free flow of resin during the injection molding process. (This step may be omitted if heating is not needed to insure the free flow of molten resin). FIG. 7D shows the base module positioned on the lower die 132 such that the positioning pins 142 mate with the position holes 122. The IC tag module 102 is pressed into the lower die until the IC tag module 102 is cradled by the lower module retention portion.

Next, the upper die 146 is set in place. FIG. 7e shows the structure formed by the upper die 146 and the lower die 132 when the upper die is set in place. Resin chamber 140 is formed around the insulating ring 104 and the outer circumference of the IC tag module 102 with through holes 124 adjacent to the injection inlets 152. If retention pins 154 are used, the pins emerge from recessed positions to secure the insulating ring 104. Positioning pins 142 are then retracted. Next, a molten resin is injected into the resin chamber 140 from the injection inlets 152 while the IC tag module 102 is cooled by the lower cooling compartment 136 and upper cooling compartment 150. When the resin cover 106 has been formed and hardened the retention pins 154 are retracted. The upper die 146 is translated up away from the lower die 132. The finished IC token 100 is then removed from the lower die 132 with or without the aid of optional ejection pins (not shown).

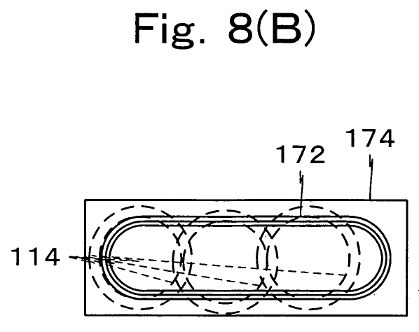

FIG. 8 shows the selection device 160 of the present invention. The selection device is embedded in a game machine 162 or other electronic device. The selection device contains a slot 164 that accepts an IC token 100. The slot 164 width and height are slightly larger than the IC token 100 width and diameter, respectively, preventing larger tokens from being introduced into the selection device 160. An inclined path 166 is formed by an inclined rail 168 and two supporting walls (not shown). The supporting walls are separated by a width slightly larger than the IC token 100 width. The inclined rail 168 is inclined down from the slot 164 so a coin introduced into the slot will roll to the end of the inclined rail 168. One of the supporting walls (not shown) may be slide-ably disposed to allow the removal of a jammed IC token 100.

When an IC token 100 is introduced into the slot 164 it will roll downhill past an optional material sensor 170 and a tag reader antenna 172 mounted on a base plate 174. The material sensor will sense the IC token 100 and alert a microprocessor 196. The tag reader antenna 172 is connected with a tag reader 202 that communicates with the microprocessor 196. When the IC token rolls by the tag reader antenna 172, the tag reader 202 will read the electronic data embedded on the IC token and communicate the information to the microprocessor 196. A tag writer 206 may also write information to the IC token 100 as the coin continues to roll by the tag reader antenna 172.

The tag reader antenna 172 is deliberately elongated to extend the amount of time the tag reader 202 and tag writer 206 can communicate with the rolling IC token 100. Optimally, the tag reader antenna 172 should be at least two times the length of the circular antenna 114.

During the read write process, the insulating ring 104 attenuates electromagnetic energy radiated in a radial direction from the circular antenna 114 preventing unintentionally or illegal access of IC token 100 data.

In this embodiment, the base plate 174 is located some distance away from the slot 164 to minimize the electromagnetic energy that escapes through the slot. The insulating ring 104 also attenuates electromagnetic energy radiating toward the slot 164. This helps prevent unintentional or illegal access of information on the IC token 100.

The optional material sensor 170 can also be used to determine the validity of the IC token 100. The material sensor 170 can check to see if the insulating ring 104 is composed of the correct material adding yet another security feature.

The microprocessor 196, will determine if the IC token 100 is valid. If the token is valid the IC token 100 will continue to the end of the inclined rail 168 where it will drop into a distribution path 176 trigger an acceptance sensor 186 via a contact element 188 and fall further into a acceptance inlet 184. When the acceptance sensor 186 is triggered, a signal is sent from the acceptance sensor 186 to the microprocessor 196 indicating that a valid IC token 100 has been deposited. If the IC token 100 is invalid the microprocessor 196 will activate a distribution gate 178 that directs the IC token to a return outlet 173 via a return path 180. Thus a regular coin, a coin from another gaming parlor or any other invalid coin will be returned to the user.

In a more complex embodiment, the IC token 100 may serve as an electronic ledger. For instance, the IC token 100 may have a value of 1000 yen. The IC token 100 will have that value stored in the IC 112. When the IC token 100 passes by the tag reader the tag reader will read the 1000 yen. The microprocessor 196 will deduct the cost of the game play, for example 100 yen. Then, the microprocessor will command the tag writer 206 to write 900 yen, the value remaining onto the IC 112. The microprocessor then triggers the distribution gate 178 feeding the IC token 100 through the return path 180 to the return outlet 173. If the microprocessor 196 calculates a zero balance the microprocessor 196 will trigger a solenoid 182 to retract the distribution gate 178 and allow the IC token 100 to fall in the acceptance inlet 184.

Those skilled in the art will appreciate that various adaptations and modifications of the just-described preferred embodiment can be configured without departing from the scope and spirit of the invention. Therefore, it is to be understood that, within the scope of the amended claims, the invention may be practiced other than as specifically described herein.

What is claimed is:

1. An IC token that comprises:
a coin-shaped IC tag module having an IC chip and an antenna;
an electromagnetic-wave absorbing ring that is arranged around the outer circumference of the coin-shaped IC tag module; and
a cover resin portion that covers the entire circumference of the electromagnetic-wave-absorbing ring and bonds the coin-shaped IC tag module and the electromagnetic-wave absorbing ring together.

2. The IC token of claim 1, wherein the electromagnetic-wave-absorbing ring is made of metal.

3. The IC token of claim 2, wherein the metal is ferromagnetic.

4. The IC token of claim 3, wherein the ferromagnetic metal is iron.

5. The IC token of claim 1, wherein the electromagnetic-wave absorbing ring has a plurality of retention portions which protrude radially inward, and the coin-shaped IC tag module is retained by these retention portions.

6. The IC token of claim 1, wherein the entire circumference of the electromagnetic-wave-absorbing ring is covered by the cover resin portion, and the outer circumference of the coin-shaped IC tag module is supported by the inner circumference of the cover resin portion.

7. An injection molding die device for an IC token that includes a coin-shaped IC tag module having an IC chip and an antenna and an electromagnetic-wave absorbing ring that is arranged around the outer circumference of the coin-shaped IC tag module, wherein the coin-shaped IC tag module and the electromagnetic-wave absorbing ring are united by a cover resin portion that covers the entire circumference of the electromagnetic-wave absorbing ring, which comprises:
a pair of module retention portions which retain both sides of the coin-shaped IC tag module respectively; and
at least one pair of dies, which can form the cover resin portion around the electromagnetic-wave absorbing ring, of a forcible cooling type, and comprises positioning pins which set the electromagnetic-wave absorbing ring to a predetermined position of the outer circumference of the coin-shaped IC tag module.

8. A method for manufacturing an IC token, comprising:
retaining an outer circumference of a coin-shaped IC tag module by inwardly protruding retention portions of a ring made of electromagnetic wave absorbing material which is to be united with the IC tag module, the surfaces of thus united coin-shaped IC tag module are retained by dies and resin injection space is formed around the ring by the dies; and
injecting resin, after the ring is retained by retention pins, into the resin injection space to form the IC token.

9. A selection device for an IC token, comprising:
a housing having a slot in the form of a slit that has its longitudinal dimension and thickness made slightly larger than the diameter and width of an IC token including a central coin-shaped IC tag module having an IC tag and an electromagnetic-wave-absorbing ring that is arranged around the outer circumference of the coin-shaped IC tag module;
an inclined guide rail that supports an IC token passing through the slot to roll in a direction of away from the slot;
an antenna that is arranged at a side of the inclined guide rail and whose length is set to be at least two times the diameter of the coin-shaped IC tag module or longer;
a reading unit that communicates with the IC token through the antenna to at least read out information from the IC tag;
a discrimination unit that discriminates whether or not the IC token should be accepted or returned based on the information read out by the reading unit; and
a distribution gate that is operated based on the discrimination result of the discrimination unit to distribute the IC token from the guide rail to a return outlet or to an acceptance inlet.

10. The selection device for an IC token as set forth in claim 9, further comprising a material sensor for the electromagnetic wave-absorbing ring.

11. An IC token for use in gaming devices comprising:
an IC tag module including an IC chip and an antenna connected with the IC chip;
a protective resin housing encapsulating the IC chip and the antenna;
an insulating ring disposed around one peripheral side of the IC tag module to block electromagnetic radiation; and
a packaging resin cover member surrounding the and insulating ring bonded to a periphery of the IC tag module.

12. The IC token of claim 11, wherein the insulating ring is made of metal.

13. The IC token of claim 12, wherein the metal is a ferromagnetic metal.

14. The IC token of claim 13, wherein the ferromagnetic metal is iron.

15. The IC token of claim 11 wherein the resin cover and the protective resin are composed of the same type of resin.

16. The IC token of claim 14 wherein the insulating ring is iron.

17. The IC token of claim 11, wherein the insulating ring includes a plurality of retention members that support the IC tag module.

18. A method of producing an IC token comprising the steps of:
inserting an IC module into an insulating ring to form a base unit;
preheating the base unit;
aligning positioning holes in the base unit with positioning pins on a lower die;
inserting the base unit onto a lower retention portion of the lower die until the lower retention portion cradles the base unit;
placing an upper die in operative relationship with the lower die;
retracting the positioning pins;
injecting molten resin into a resin chamber formed by the lower die and the upper die to cover the insulating ring and interconnect the insulating ring with the IC module;
permitting the molten resin to harden; and
removing the IC token from the dies.

19. An injection molding die for an injection molding of a resin cover to a base unit to form an IC token, the injection molding die comprising:
a lower die including:
a lower retention portion of a size to receive a center portion of a first side of the base unit;
a concave portion adjacent to the lower retention portion that is below the periphery of the base unit; and
a plurality of positioning pins slideably disposed in the lower die that are operatively designed to extend into the concave portion and mate with positioning holes in the base unit; and
an upper die including:
an upper retention portion of a size to receive the center portion of a second side of the base unit; and
a wall structure adjacent to the upper retention portion wherein the upper die rests on the lower die and the wall structure and the concave portion forms a chamber around the periphery of the base unit.

20. A selection device for an IC token, comprising:
housing having a slot for accepting the IC token;
an inclined guide rail that extends downward from the slot to enable a gravity feed of the IC token;
a first sidewall and a second side wall that guide the IC token along the inclined guide rail;
an antenna operatively positioned adjacent the inclined rail;
a tag reader unit connected with the antenna that reads information embedded in the IC token;
a microprocessor connected with the tag reader and operative to process an input from the tag reader; and
a distribution gate actuated by the microprocessor to route the IC token based on the information embedded in the IC token to one of a plurality of predetermined destinations.
